(19) United States
(12) Patent Application Publication
(10) Pub. No.: US 2012/0026300 A1
(43) Pub. Date: Feb. 2, 2012

(54) IMAGING APPARATUS

(76) Inventors: Kenji KAKIUCHI, Osaka (JP); Kazumasa Tabata, Osaka (JP); Takanori Yabuki, Osaka (JP); Masahiro Murakami, Kyoto (JP); Atsushi Matsui, Kyoto (JP)

(21) Appl. No.: 13/191,679

(22) Filed: Jul. 27, 2011

(30) Foreign Application Priority Data
Jul. 27, 2010 (JP) 2010-167983
Aug. 19, 2010 (JP) 2010-183587

(51) Int. Cl. H04N 13/02

(52) U.S. Cl. 348/49; 348/E13.074

(57) ABSTRACT

An imaging apparatus can connect a 3D conversion lens. The 3D conversion lens has an optical system capable of collecting light for forming a left-eye image and light for forming a right-eye image. The imaging apparatus has an imaging device, a zoom lens operable to change a magnification of an image to be imaged on the imaging device, a driver operable to drive the zoom lens, a temperature detector operable to detect an ambient temperature of the apparatus, an attachment detector operable to detect whether the 3D conversion lens is attached to the apparatus, and a controller operable to control the driver to cause the zoom lens to move to a predetermined position, when the attachment detector detects that the 3D conversion lens is attached to the apparatus. The controller determines the predetermined position based on a detected result of the temperature detector.

### BACKGROUND

1. Technical Field

The technical field relates to an imaging apparatus. The technical field particularly relates to the imaging apparatus to/from which a 3D conversion lens can be attached/detached.

2. Related Art

Japanese Patent Application JP-2001-222083-A discloses an imaging apparatus. A 3D conversion lens (dual lens adapter) can be attached to the imaging apparatus. The imaging apparatus to which the 3D conversion lens is attached can image a three-dimensional stereoscopic image (3D image). When a power of the imaging apparatus is ON with the 3D conversion lens being attached thereto, the imaging apparatus changes a focal position of a zoom lens to a wide end.

With this arrangement, this 3D conversion lens does not have to support all zoom regions of the imaging apparatus.

### SUMMARY

However, for the imaging apparatus disclosed in JP-2001-222083-A, it is assumed that the 3D conversion lens is attached to the imaging apparatus at a time of power OFF. For this reason, when the 3D conversion lens (a dual lens adapter) is attached at a time of power ON, an abnormal image may be recorded.

The imaging apparatus to which the 3D conversion lens can be attached further has the following problem.

For example, as a supporting member or the like for supporting lenses included in an optical system expands/contracts due to a change in ambient temperature, a distance between lenses in the 3D conversion lenses changes. When the distance between the lenses changes, a distance from the imaging apparatus to a 3D image reference plane (a plane where a parallax amount between a left-eye image and a right-eye image in the 3D image becomes zero, namely, a plane where a projecting amount (or retrojecting amount) in a 3D image becomes zero) changes. That is to say, the position of the reference plane (hereinafter, suitably “reference plane position”) changes. As a result, the captured 3D image might be a 3D image that provides bad visibility to a user.

When an electronic zoom (zoom not by means of the optical system but zoom by electronically processing an image captured on an imaging device so as to enlarge the image) is performed during the attachment of the 3D conversion lens and photographing a 3D image, the parallax amount between a left-eye image and a right-eye image changes according to an electronic zoom magnification. For this reason, the projecting amount or the retrojecting amount of a 3D image becomes extremely large due to an electronic zoom operating amount, and thus the user cannot visually recognize the 3D image satisfactorily.

### SUMMARY

In view of above problems, firstly, there is provided an imaging apparatus with the 3D conversion lens (dual lens adapter) is attached thereto that can prevent recording of a 3D image which is hard to be visually recognized by a user according to a change in ambient temperature. Secondly, there is provided an imaging apparatus which can prevent an abnormal image from being recorded even when the 3D conversion lens adapter is attached in a time of power ON. Thirdly, there is provided an imaging apparatus that can prevent incapability of user's satisfactorily recognizing a 3D image when the imaging apparatus to which the 3D conversion lens is attached performs electronic zoom.

An imaging apparatus according to the first aspect can attach a 3D conversion lens having an optical system capable of collecting light for forming a left-eye image and light for forming a right-eye image. The imaging apparatus includes an imaging device, a zoom lens operable to change a magnification of an image to be imaged on the imaging device; a driver operable to drive the zoom lens, a temperature detector operable to detect an ambient temperature of the apparatus, an attachment detector operable to detect whether the 3D conversion lens is attached to the apparatus, and a controller operable to control the driver to cause the zoom lens to move to a predetermined position, when the attachment detector detects that the 3D conversion lens is attached to the apparatus. The controller determines the predetermined position based on a detected result of the temperature detector.

An imaging apparatus according to the second aspect can attach a 3D conversion lens having an optical system capable of collecting light for forming a left-eye image and light for forming a right-eye image. The imaging apparatus includes an imaging device, a recorder operable to record image data captured by the imaging device in a storage medium, a zoom lens operable to change a magnification of an image to be imaged on the imaging device, a driver operable to drive the zoom lens, an attachment detector operable to detect whether the 3D conversion lens is attached to the apparatus, and a controller operable to, control the recorder to stop the recording of the image data when the attachment detector detects that the 3D conversion lens is attached to the apparatus during the recording of the image data, and thereafter control the driver to cause the zoom lens to move to a predetermined position.

An imaging apparatus according to the third aspect can attach a 3D conversion lens having an optical system capable of collecting light for forming a left-eye image and light for forming a right-eye image. The imaging apparatus includes an imaging device, a zoom lens operable to change a magnification of an image to be imaged on the imaging device, a driver operable to drive the zoom lens, an electronic zoom unit operable to electronically process the image imaged on the imaging device to enlarge the image, and a controller operable to control the driver so that a parallax amount between the left-eye image and the right-eye image is not a predetermined amount or more, and move the zoom lens, when the electronic zoom unit enlarges the image which is imaged on the imaging device.

In the imaging apparatus according to the first aspect, when the 3D conversion lens is attached to the apparatus, a zoom lens is moved to a predetermined position. At this time, the predetermined position is determined based on ambient temperature of the apparatus. As a result, in a state that the 3D conversion lens is attached to the apparatus, the zoom lens can be moved to a position according to the ambient temperature of the apparatus. For example, the zoom lens may be moved so that a reference plane position with respect to the distance between the 3D conversion lenses is not changed according to the temperature change. As a result, the reference plane position is fixed regardless of the ambient temperature. That is to say, a projecting amount (retrojecting amount) of the 3D image is prevented from changing due to the temperature change. Therefore, satisfactory 3D images can be provided to the user.

In the imaging apparatus according to the second aspect, when the 3D conversion lens is attached to the apparatus at the time of power ON, recording of image data is stopped, and thereafter the zoom lens is moved to the predetermined position. As a result, even when the 3D conversion lens is attached in the time of power ON, abnormal images are not presented to the user.

In the imaging apparatus according to the third aspect, when an image imaged on the imaging device by the electronic zoom is enlarged, the zoom lens is moved so that the parallax amount between a left-eye image and a right-eye image does not become a predetermined amount or more. As a result, even when the electronic zoom is performed, the user can visually recognize 3D images satisfactorily.

### BRIEF DESCRIPTION OF DRAWINGS

FIG. 1 is a perspective view illustrating a state that a 3D conversion lens is attached to a digital video camera.

FIG. 2 is a perspective view illustrating a state that the 3D conversion lens is detached from the digital video camera.

FIG. 3 is a configurational diagram illustrating an optical system of the 3D conversion lens.

FIG. 4 is a diagram for describing image data captured by the digital video camera to which the 3D conversion lens is attached.

FIG. 5 is a block diagram illustrating a configuration of the digital video camera.

FIG. 6 is a flowchart for describing an operation at a time when attachment of the 3D conversion lens is detected in a state that image data is not recorded.

FIG. 7 is a diagram for describing an image to be displayed on a liquid crystal monitor at a time of initial setting in a 3D mode of the digital video camera.

FIG. 8 is a flowchart for describing an operation in a case where the attachment of the 3D conversion lens is detected in the state that image data is recorded.

FIG. 9 is a diagram for describing an image to be displayed on the liquid crystal monitor.

FIG. 10 is a flowchart illustrating an operation in a case where a power is turned on by a user.

FIG. 11 is a diagram for describing a relationship between an ambient temperature and a focal distance of the optical system of the digital video camera main body.

FIG. 12 is a diagram for describing why the digital video camera changes a moving position of a zoom lens according to the ambient temperature.

FIG. 13 is a diagram for describing an operation for changing a reference plane position at a time of an electronic zoom.

FIG. 14 is a diagram for describing a change in the reference plane position at the time of the electronic zoom (when a subject is closer to an infinite side than the reference plane position).

FIG. 15 is a diagram for describing a change in the reference plane position at the time of the electronic zoom (a subject is closer to a close side than the reference plane position).

FIG. 16 is a diagram for describing a screen for changing the reference plane position by a user.

### DETAILED DESCRIPTION OF PREFERRED EMBODIMENT

### 1. First Embodiment

A first embodiment will be described with reference to the drawings.

### 1-1. Outline

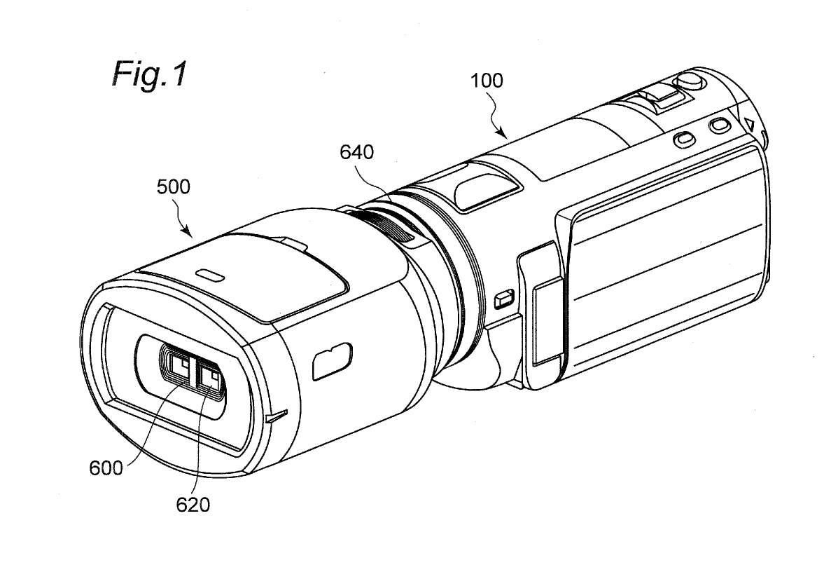

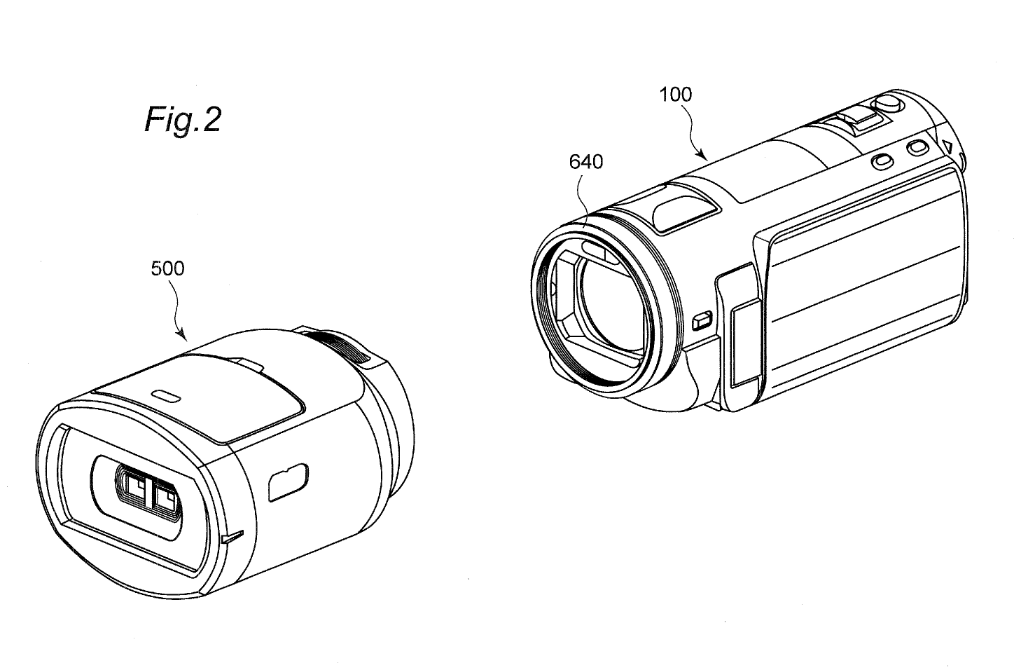

An outline of a digital video camera 100 according to the first embodiment will be described with reference to FIGS. 1 to 3. FIG. 1 is a perspective view illustrating a state that a 3D conversion lens 500 is attached to the digital video camera 100. FIG. 2 is a perspective view illustrating a state that the 3D conversion lens 500 is detached from the digital video camera 100.

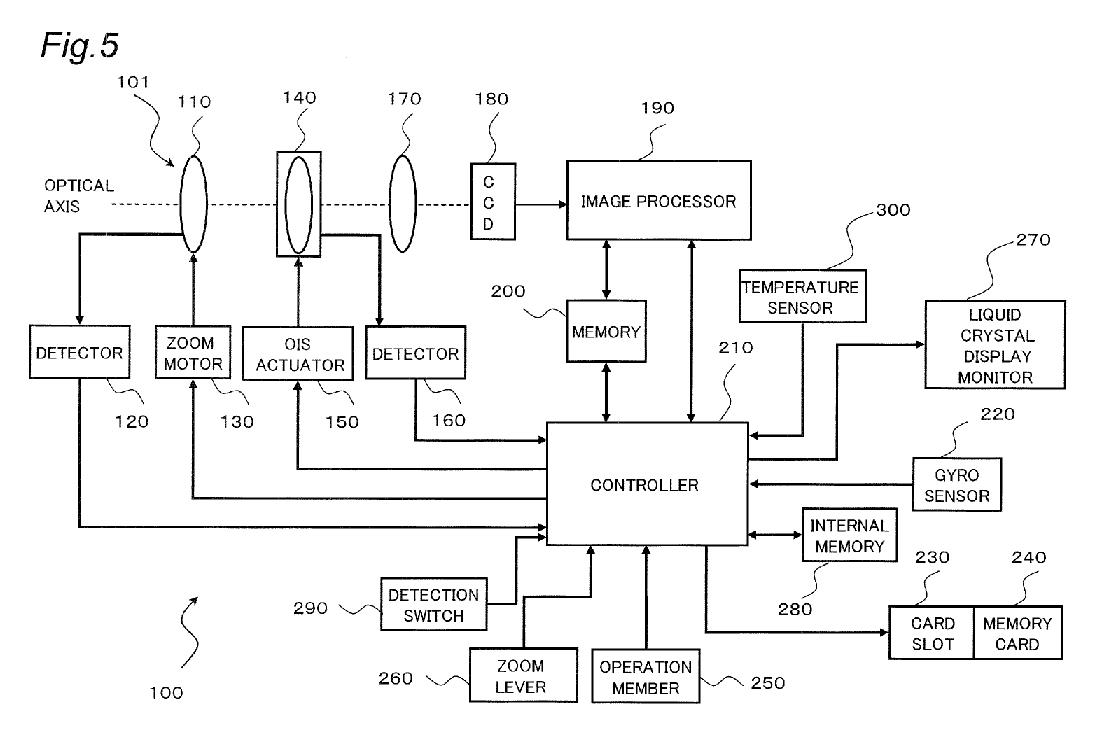

As shown in FIG. 1, the digital video camera 100 has a mounting section 640 for mounting the 3D conversion lens 500. The mounting section 640 has a female screw inside. On the other hand, the 3D conversion lens 500 has a male screw that is engaged with the female screw provided to the mounting section 640. A user allows the male screw of the 3D conversion lens 500 to be engaged with the female screw of the mounting section 640, so that the 3D conversion lens 500 can be attached to the digital video camera 100. The digital video camera 100 enables a detecting switch 290 (see FIG. 5 described later) to magnetically detect that the 3D conversion lens 500 is attached.

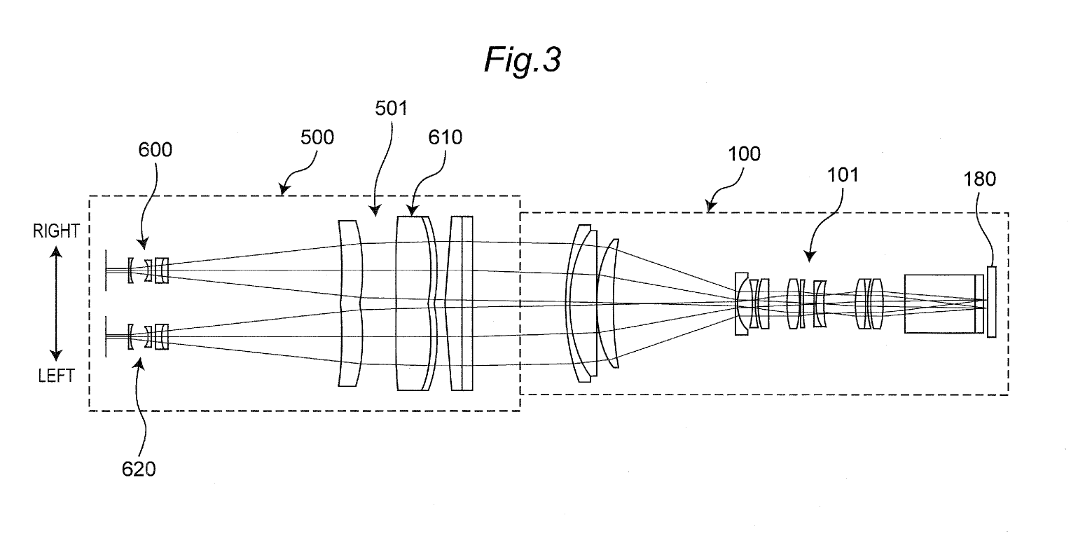

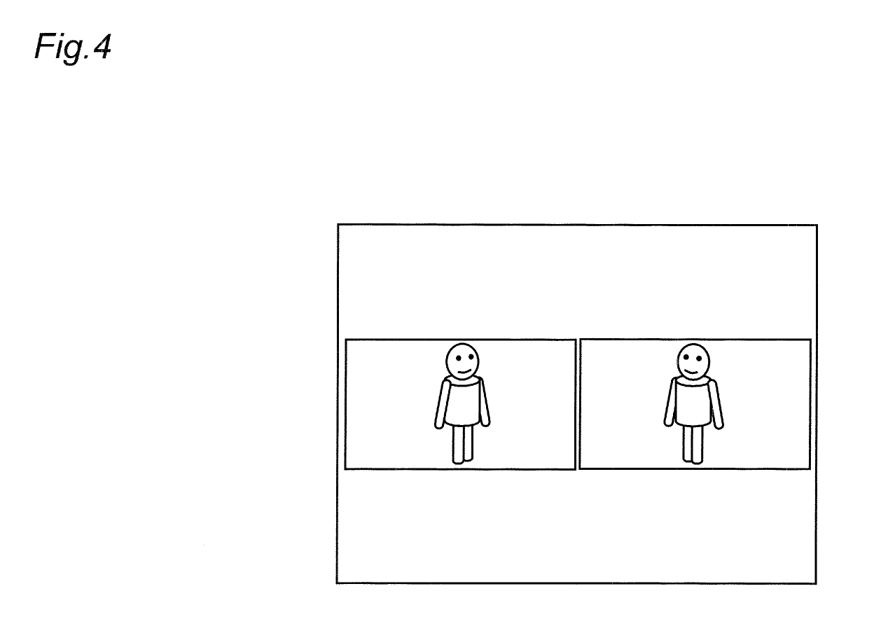

FIG. 3 is a diagram illustrating a configuration of the 3D conversion lens 500 and an optical system 501 of the digital video camera 100. The optical system 501 of the 3D conversion lens 500 includes a right-eye lens 600, a left-eye lens 620 and a common lens 610. The right-eye lens 600 guides light for forming a right-eye image in a 3D (three dimensions) image. The left-eye lens 620 guides light for forming a left-eye image in a 3D image. The common lens 610 is configured by integrating a right-eye and a left-eye lens in order to guide the light incident to the right-eye lens 600 and the left-eye lens 620 to an optical system 101 of the digital video camera 100. The light incident to the right-eye lens 600 and the left-eye lens 620 of the 3D conversion lens 500 is guided to the optical system 101 of the digital video camera 100 via the common lens 610. The light then is imaged as a side-by-side format image shown in FIG. 4, for example, on CCD image sensor 180 of the digital video camera 100 (see FIG. 5 described later). The digital video camera 100 images a 3D image shown in FIG. 4, and can record it in a recording medium such as a memory card 240 (see FIG. 5 described later). On the other hand, in a state that the 3D conversion lens 500 is not attached, the digital video camera 100 can image a normal 2D image and record it in the recording medium such as the memory card 240. Hereinafter, a mode in which a 3D image is captured and recorded in the memory card 240 is called as “3D mode”, and a mode in which a 2D image is captured and recorded in the memory card 240 is called as “2D mode”.

### 1-2. Configuration

### 1-2-1. Configuration of Digital Video Camera

An electrical configuration of the digital video camera 100 according to the first embodiment will be described with reference to FIG. 5. FIG. 5 is a block diagram illustrating a configuration of the digital video camera 100. The digital video camera 100 has an optical system 101, a CCD image sensor 180, an image processor 190, a liquid crystal display monitor 270, a detector 120, a zoom motor 130, an OIS actuator 150, a detector 160, a memory 200, a controller 210, a zoom lever 260, an operation member 250, an internal memory 280, a gyro sensor 220, a card slot 230, and a detection switch 290. The digital video camera 100 captures a subject image formed by the optical system 101 using the CCD image sensor 180. Video data generated by the CCD image sensor 180 is subject to various processes in the image processor 190, and is stored in a memory card 240. Further, the video data stored in the memory card 240 can be displayed on the liquid crystal display monitor 270. The configuration of the digital video camera 100 will be described in detail below.

The optical system 101 of the digital video camera 100 includes a zoom lens 110, an OIS 140, and a focus lens 170. The zoom lens 110 moves along an optical axis of the optical system 101 so as to be capable of enlarging or reducing a subject image. The focus lens 170 moves along the optical axis of the optical system 101 to adjust a focus of the subject image.

The OIS 140 has a correction lens that can move in a plane vertical to the optical axis inside. The OIS 140 drives the correction lens to a direction where a shake of the digital video camera 100 is cancelled to reduce a shake of a subject image.

The zoom motor 130 drives the zoom lens 110. The zoom motor 130 may be realized by a pulse motor, a DC motor, a linear motor, or a servo motor. The zoom motor 130 may drive the zoom lens 110 via a cam mechanism or a mechanism such as a ball screw. The detector 120 detects a position on the optical axis where the zoom lens 110 is present. The detector 120 outputs a signal relating to a position of the zoom lens using a switch such as a brush according to the motion of the zoom lens 110 to a direction of the optical axis.

The CIS actuator 150 drives the correction lens in the OIS 140 in a plane vertical to the optical axis. The OIS actuator 150 can be realized by a planar coil, an ultrasonic motor or the like. Further, the detector 160 detects a motion range of the correction lens in the OIS 140.

The CCD image sensor 180 captures the subject image formed on the optical system 101 to generate video data. The CCD image sensor 180 performs various operations such as exposure, transfer and electronic shutter.

The image processor 190 executes various processes on the video data generated by the CCD image sensor 180. The image processor 190 generates video data to be displayed on the liquid crystal display monitor 270, and generates video data to be restored in the memory card 240. For example, the image processor 190 executes various processes such as gamma correction, white balance correction, and scrape correction on the video data generated by the CCD image sensor 180. The image processor 190 compresses the video data generated by the COD image sensor 180 according to a compressing format conforming to H. 264 standards and MPEG2 standards. The image processor 190 can be realized by a DSP or a microcomputer.

The controller 210 is a controller for controlling the entire operation of the digital video camera. The controller 210 can be realized by a semiconductor element or the like. The controller 210 may be composed of only hardware or by combining hardware and software. The controller 210 can be realized by a microcomputer or the like.

The memory 200 functions as work memories of the image processor 190 and the controller 210. The memory 200 can be realized by, for example, a DRAM or a ferroelectric memory.

The liquid crystal display monitor 270 can display an image represented by the video data generated by the CCD image sensor 180 and an image represented by the video data read from the memory card 240.

The gyro sensor 220 includes a vibration material such as a piezoelectric element. The gyro sensor 220 converts a force caused by a Coriolis force at a time of vibrating the vibration material such as the piezoelectric element at a constant frequency into a voltage to acquire angular velocity information. The digital video camera 100 acquires the angular velocity information from the gyro sensor 220, and drives the correction lens in the OIS 140 to a direction where the shake is cancelled, to correct a camera shake caused by a user.

The memory card 240 can be attached to/detached from the card slot 230. The card slot 230 can be mechanically and electrically connected to the memory card 240. The memory card 240 includes a flash memory and a ferroelectric memory, and can store data.

The internal memory 280 includes a flash memory or a ferroelectric memory. The internal memory 280 stores a control program or the like for entirely controlling the digital video camera 100.

The operation member 250 is a member that accepts an operation from the user. The zoom lever 260 is a member that accepts an instruction for changing zoom magnification from the user.

The detection switch 290 can magnetically detect that the 3D conversion lens 500 is attached to the digital video camera 100 (connected). When the detection switch 290 detects the attachment of the 3D conversion lens 500, it outputs a signal representing the attachment to the controller 210. As a result, the controller 210 can detect that the 3D conversion lens 500 is attached to and detached from the digital video camera 100.

A temperature sensor 300 detects an ambient temperature of the digital video camera 100. For example, the temperature sensor 300 is composed of a thermistor or the like. The temperature sensor 300 may detect temperature of the digital video camera 100.

### 1-2-2. Correspondence

The 3D conversion lens 500 is one example of the 3D conversion lens. The optical system 501 is one example of an optical system. The CCD image sensor 180 is one example of an imaging device. A controller 210 is one example of a recorder. A zoom lens 110 is one example of a zoom lens. A zoom motor 130 is one example of a driver. The detecting switch 290 is one example of an attachment detector. A liquid crystal display monitor 270 is one example of a display.

### 1-3. Operation

### 1-3-1. Operation After Detection of Attachment of the 3D Conversion Lens (During No-Recording)

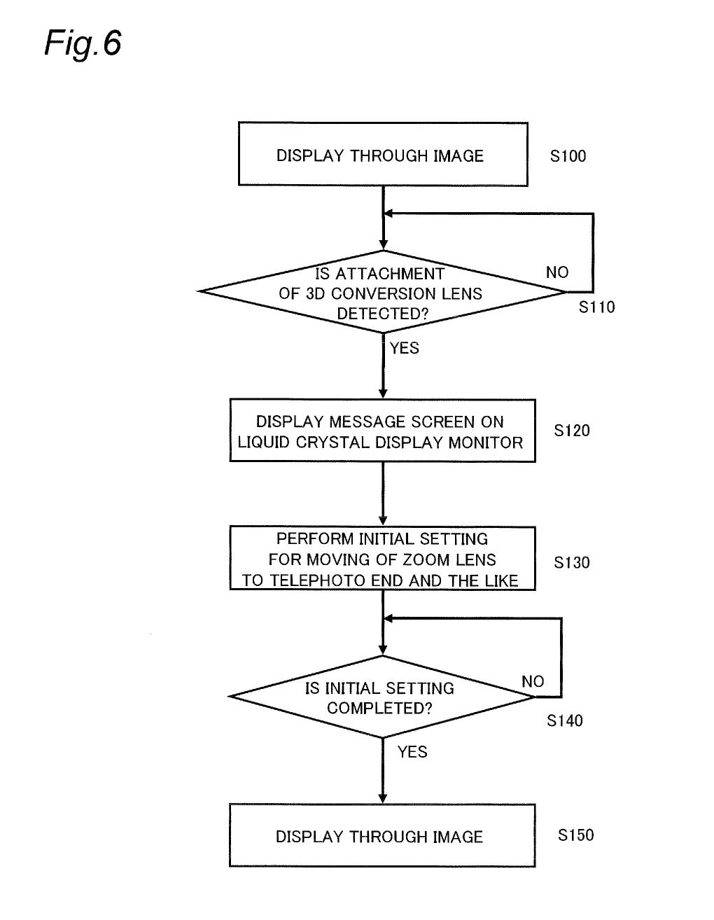

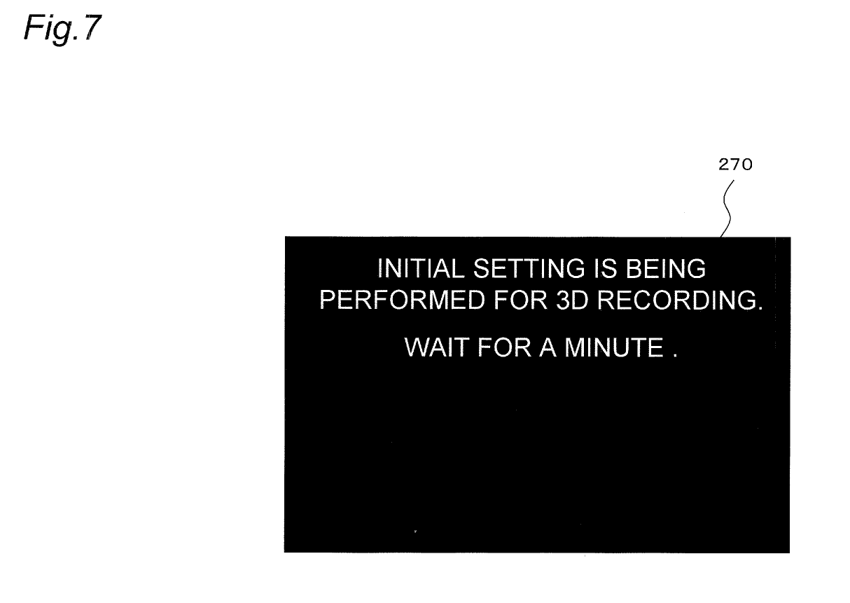

An operation of the digital video camera 100 in the case of detecting the attachment of the 3D conversion lens 500 in a state that image data is not recorded will be described with reference to FIGS. 6 and 7. FIG. 6 is a flowchart for describing the operation of the digital video camera 100 in the case of detecting the attachment of the 3D conversion lens 500 in the state that image data is not recorded. FIG. 7 is a diagram for describing an image to be displayed by the liquid crystal display monitor 270 at a time of initial setting in the 3D mode of the digital video camera 100.

When the digital video camera 100 is set to a recording mode, it displays a through image on the liquid crystal display monitor 270 (S100). The through image is an image displayed by displaying an image that is currently imaged on the CCD image sensor 180 via the optical system 501 of the 3D conversion lens 500 and the optical system 101 of the digital video camera 100 as it is. In a state that the through image is displayed on the liquid crystal display monitor 270, the controller 210 monitors and determines that the 3D conversion lens 500 is attached to the digital video camera 100 (S110).

When the determination is made that the 3D conversion lens 500 is attached, the controller 210 controls the liquid crystal display monitor 270 to display an image shown in FIG. 7 (S120). Concretely, the liquid crystal display monitor 270 displays message such as “3D recording is being initially set. Wait for a minute.” with white characters on a black background. That is to say, the liquid crystal display monitor 270 displays an image different from the through image captured by the CCD image sensor 180. Data of the image shown in FIG. 7 is stored in an internal memory 280. It is noted that the data of the characters of the above message may be stored in the internal memory 280 and the above image with white characters on a black background shown in the FIG. 7 may be generated by using the stored character data.

In a state that the message image shown in FIG. 7 is displayed on the liquid crystal display monitor 270, the controller 210 performs initial setting in the 3D mode of the entire digital video camera 100 (S130). For example, as the initial setting, the controller 210 controls the zoom motor 130 to move a zoom lens 110 to a telephoto end. The controller 210 sets the digital video camera 100 into a mode in which the zoom motor 130 is not controlled even when an operation of a zoom lever 260 is received from a user. This is because when the focal distance is frequently changed in the 3D mode, parallax of an captured image changes, so that the captured image might be an image that is less-visible for the user. For this reason, the digital video camera 100 according to the first embodiment is configured to move the zoom lens 110 to a predetermined position on the initial setting in the 3D mode so that the parallax of the captured image becomes suitable, and thereafter not to move the zoom lens 110. In the first embodiment, the predetermined position is the telephoto end, but is not limited to this. The controller 210 sets the digital video camera 100 to a mode for limiting a range of moving a correction lens in an OILS 140 further than a case where the 3D conversion lens 500 is not attached.

When the initial setting in the 3D mode is started, the controller 210 determines whether the initial setting in the 3D mode of the entire digital video camera 100 is completed (S140). When the determination is made that the initial setting in the 3D mode is completed, the controller 210 stops the display of the message image shown in FIG. 7, and controls the liquid crystal display monitor 270 to display the through image captured by the CCD image sensor 180 (S150). In this state, the controller 210 stands by until receiving an instruction for starting the recording image from the user. During the time from the attachment of the 3D conversion lens 500 to the digital video camera 100 to the completion of the initial setting in the 3D mode, the controller 210 does not receive the instruction for starting the recording image from the user. This is because the image captured by the CCD image sensor 180 during the initial setting in the 3D mode is less visible due to an automatic change in a field angle or the like occurring during the initial setting.

### 1-3-2. Operation After the Detection of the Attachment of the 3D Conversion Lens (in Recording)

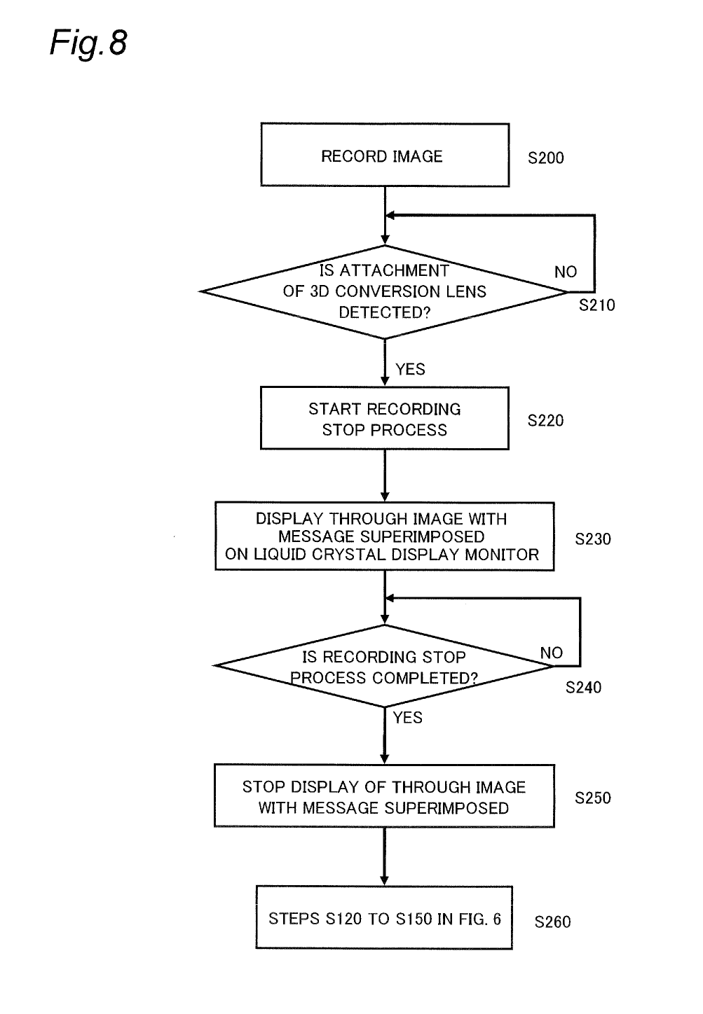

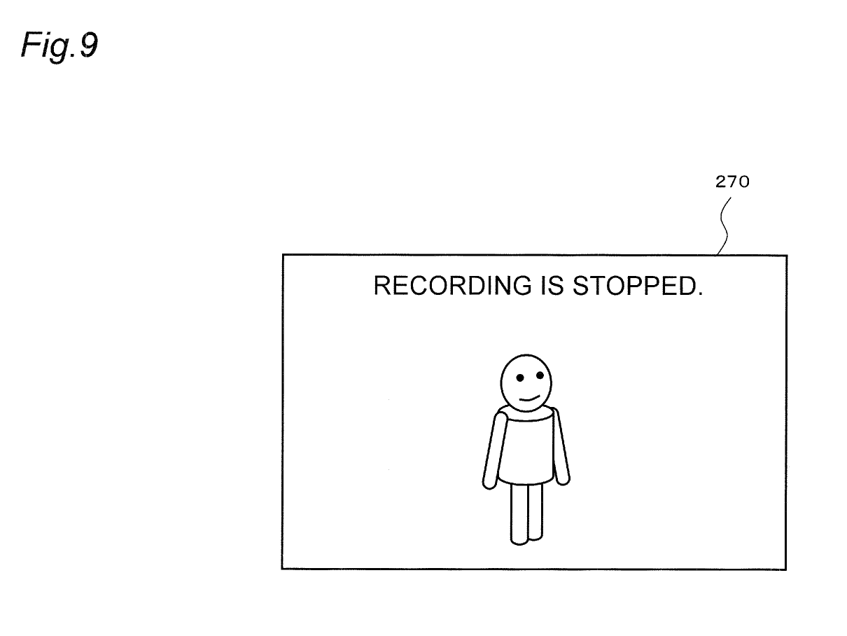

An operation of the digital video camera 100 for detecting the attachment of the 3D conversion lens 500 in a state that image data is recorded will be described with reference to FIGS. 8 and 9. FIG. 8 is a flowchart for describing the operation of the digital video camera 100 for detecting the attachment of the 3D conversion lens 500 in the state that image data is recorded. FIG. 9 is a diagram for describing an image to be displayed by the liquid crystal display monitor 270.

While the digital video camera 100 is recording image data (S200), the controller 210 monitors and determines whether the 3D conversion lens 500 is attached (S210).

When the determination is made that the 3D conversion lens 500 is attached, the controller 210 starts a process for stopping the recording of the image data captured by the CCD image sensor 180 in the memory card 240 (S220). When the recording stop process is started, the controller 210 controls the liquid crystal display monitor 270 to display an image on which the message shown in FIG. 9 is superimposed (S230). Concretely, the controller 210 causes the liquid crystal display monitor 270 to display an image, as shown in FIG. 9, on which a message “the recording is stopped” written by white characters is superimposed on the through image captured by the CCD image sensor 180.

When the image on which the message shown in FIG. 9 is superimposed is displayed on the liquid crystal display monitor 270, the controller 210 monitors whether the process for stopping the recording of the image data captured by the CCD image sensor 180 in the memory card 240 is completed (S240). When the determination is made that the recording stop process is completed, the controller 210 controls the liquid crystal display monitor 270 to stop the display of the image on which the message shown in FIG. 9 is superimposed (S250).

When the display of the image on which the message shown in FIG. 9 is superimposed on the liquid crystal display monitor 270 is stopped, the controller 210 controls the digital video camera 100 to execute the process from step 5120 to step S150 in the flowchart of FIG. 6 (S260).

In the digital video camera 100 according to the first embodiment, when the 3D conversion lens 500 is attached during the recording of image data, after the recording of the image data is stopped, the initial setting in the 3D mode is performed. That is to say, the recording of the image data is suspended before the initial setting is performed according to the attachment of the 3D conversion lens 500. This prevents an abnormal image from being recorded due to the automatic change in the field angle caused by the change in the position of the zoom lens 110 at the time of the initial setting in the 3D mode. Further, at the time of the initial setting caused by switching from the 2D mode to the 3D mode, an image format is switched, namely, electric switching is performed. According to the first embodiment, turbulence of an image or the like at the time of the switching can be prevented from being recorded.

In the digital video camera 100 according to the first embodiment, a through image is not displayed on the liquid crystal display monitor 270 at the time of the initial setting in the 3D mode. As a result, the digital video camera 100 can prevent the automatic change in the field angle during the initial setting in the 3D mode from being viewed by the user.

In the digital video camera 100 according to the first embodiment, during the time from the attachment of the 3D conversion lens 500 to the completion of the initial setting in the 3D mode, the instruction for starting the recording is not received from the user. As a result, the digital video camera 100 can prevent the recording of an abnormal image where the field angle is automatically changed at the time of the initial setting in the 3D mode.

When the 3D conversion lens 500 is detached during the recording of 3D image data, the digital video camera 100 stops the recording of the image data. Further, the digital video camera 100 controls the liquid crystal display monitor 270 to display the image on which the message shown in FIG. 9 is superimposed after starting to stop the recording of the image data. This can prevent 2D image data and 3D image data from being mixed in one image file.

### 2. Second Embodiment

A second embodiment will be described with reference to the drawings. Description about the same configuration as that of the digital video camera 100 according to the first embodiment will be omitted.

When the 3D conversion lens 500 is attached to the digital video camera 100 according to the second embodiment, as the initial setting in the 3D mode, the zoom lens is moved to the side of the telephoto end. However, differently from the first embodiment, the zoom lens is moved not to one point of the telephoto end but to a predetermined position near the telephoto end according to an ambient temperature.

A problem of the second embodiment will be first described. The distance between the lenses in the 3D conversion lens changes according to the expansion/contraction of the supporting member for supporting the lenses including the optical system or the like according to the change in the ambient temperature. When the distance between the lenses changes, a distance from the imaging apparatus to a position of a reference plane of a 3D image (a position where a parallax amount between a left-eye image and a right-eye image is zero, namely, a position where a projecting amount of the 3D image (retrojecting amount) is zero) changes. As a result, there is a problem that the captured 3D image is occasionally a 3D image that is less visible for the user. In order to solve the above problem, when the 3D conversion lens 500 is attached to the digital video camera 100 according to the second embodiment, the digital video camera 100 determines a position to which the zoom lens 110 moves according to the ambient temperature. (1) An operation for determining a moving position of the zoom lens and (2) a concrete example of the above problem will be described below.

### 2-1. Operation for Determining the Moving Position of the Zoom Lens

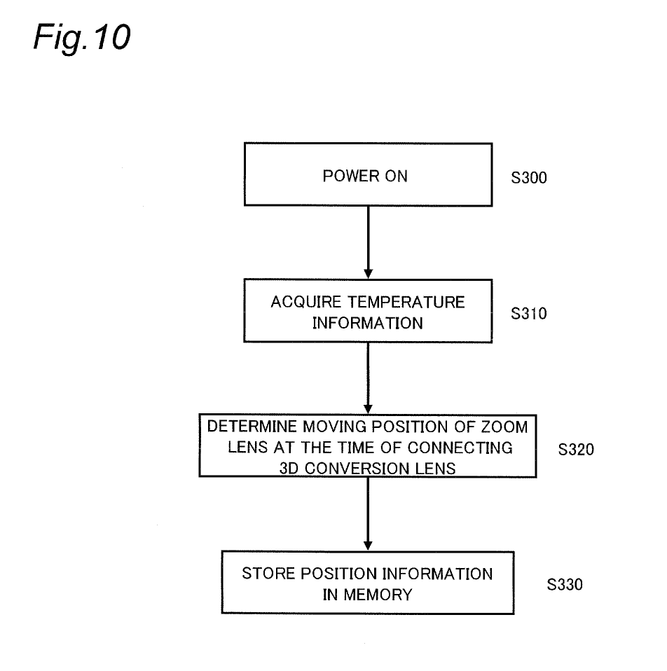

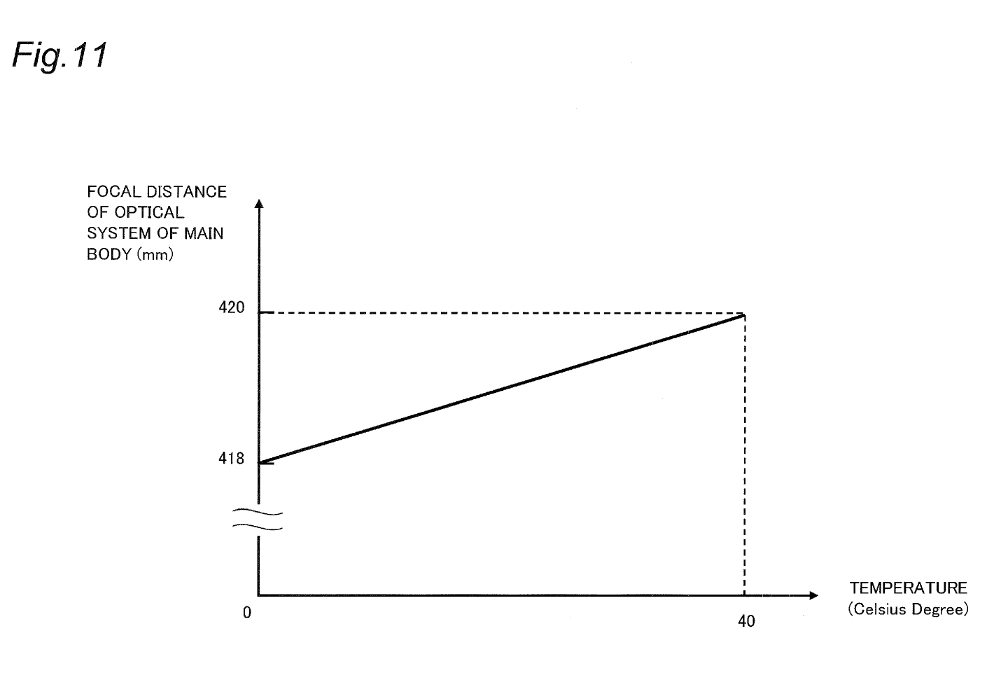

The operation for determining the moving position of the zoom lens in the digital video camera 100 according to the second embodiment will be described with reference to FIGS. 10 and 11. FIG. 10 is a flowchart illustrating the operation for determining the moving position of the zoom lens. FIG. 11 is a diagram illustrating a relationship between the ambient temperature and the focal distance of the optical system of the digital video camera 100 main body.

When the power of the digital video camera 100 (S300) is turned on by the user, the controller 210 acquires information about the ambient temperature from the temperature sensor 300 (S310). When the information about the ambient temperature is acquired, the controller 210 determines the moving position of the zoom lens 110 as an initial setting position at the time when the 3D conversion lens 500 is attached (S320). Concretely, the controller 210 obtains the focal distance of the optical system 101 of the digital video camera 100 main body corresponding to the ambient temperature according to the relationship shown in FIG. 11, and determines the moving position of the zoom lens 110 that realizes the focal distance. The relationship shown in FIG. 11 between the ambient temperature and the focal distance of the optical system 101 of the digital video camera 100 main body is set in the following manner. That is to say, even when the distance between the lenses in the 3D conversion lens 500 changes due to the temperature change, the focal distance of the optical system 101 of the digital video camera 100 main body is set as a focal distance according to the temperature at that time and thus the relationship is set so that the reference plane position of the 3D image is not changed. When the moving position of the zoom lens 110 is determined, the controller 210 stores information about the determined moving position to a memory 200.

Thereafter, after the attachment of the 3D conversion lens 500 is detected (non-recording time), the controller 210 performs a control according to the flowchart of FIG. 6 in principle. At step S130 in FIG. 6, the controller 210 moves the zoom lens 110 to the moving position represented by the information stored in the memory 200 to change the focal distance. After the attachment of the 3D conversion lens 500 is detected (recording time), the controller 210 performs a control according to a flowchart of FIG. 8 in principle. At step 5260 of FIG. 8, the controller 210 moves the zoom lens 110 to the moving position represented by the information stored in the memory 200 so as to change the focal distance.

### 2-2. With Regard to Concrete Example of the Problem

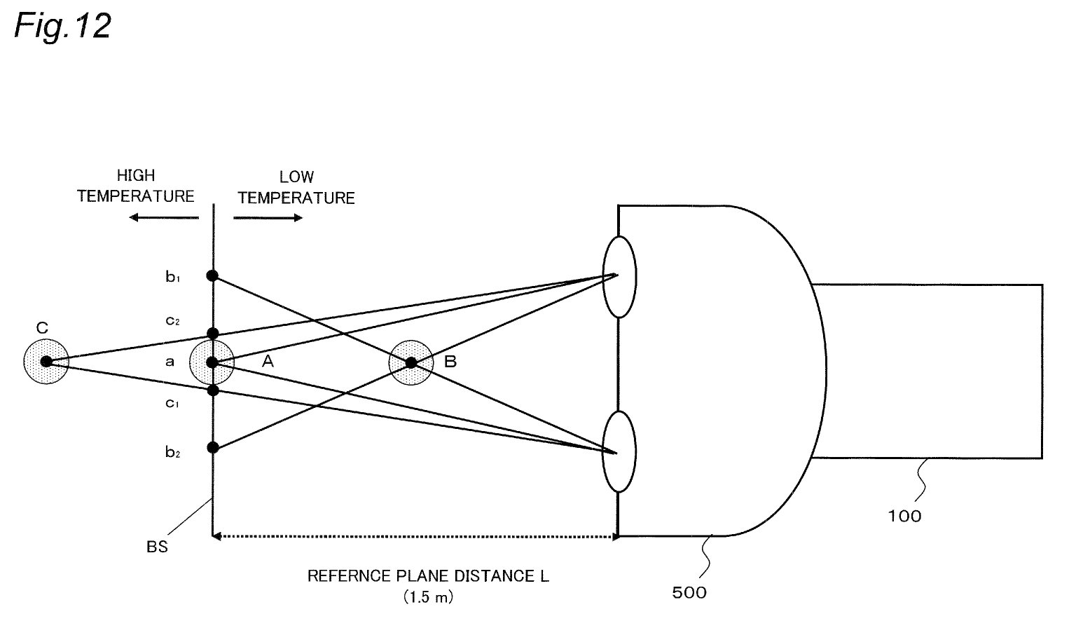

A concrete example of the above problem or the like will be described below with reference to FIG. 12.

As shown in FIG. 12, the digital video camera 100 to which the 3D conversion lens 500 is attached has a reference plane BS where the parallax between a left-eye image and a right-eye image becomes zero. As to a subject A present on the reference plane BS, the parallax becomes zero on the reference plane BS. The reference plane BS is set to a position separated from the 3D conversion lens 500 by a predetermined distance L. In the second embodiment, the predetermined distance L is set to 1.5 m.

As to a subject B present on a side closer to the 3D conversion lens 500 than the reference plane BS, parallax is caused between a left-eye image b1 and a right-eye image b2 on the reference plane BS. When the image obtained by imaging such a subject B is displayed three-dimensionally, the subject B is viewed by the user as if the subject B is present closer to the user than the screen (the subject B is jumped out from the screen).

On the other hand, as to a subject C that is present farther from the 3D conversion lens 500 than the reference plane BS, parallax is caused between a left-eye image c1 and a right-eye image c2 on the reference plane BS. When the image obtained by imaging such a subject C is displayed three-dimensionally, the subject C is viewed by the user as if the subject B is farther than the screen (present back from the screen).

A phenomenon such that the distance from the 3D conversion lens 500 to the reference plane BS changes according to the ambient temperature occurs. As a factor that causes such a phenomenon, it is considered that the 3D conversion lens 500 has a temperature property. Concretely, the parts that support the lenses of the 3D conversion lens 500 expand/contract according to the ambient temperature, and an interval between right and left optical axes and an interval of optical axis directions of the plurality of lenses change. In the 3D conversion lens 500 according to the second embodiment, when the ambient temperature becomes higher than a standard temperature, the reference plane BS goes away from the 3D conversion lens 500, and when the ambient temperature is lower than the standard temperature, the reference plane BS closes to the 3D conversion lens 500. On the other hand, when the zoom lens 110 of the digital video camera 100 is moved to the telephoto end, the reference plane BS closes to the 3D conversion lens 500, and when it is moved to a wide-angle end, the reference plane BS goes away from the 3D conversion lens 500.

In the digital video camera 100 according to the second embodiment, when the 3D conversion lens 500 is attached, the position to which the zoom lens 110 is moved is changed according to the ambient temperature. Concretely, in the digital video camera 100 according to the second embodiment, when the ambient temperature is higher than the standard temperature, the zoom lens 110 is moved towards the telephoto end, and when the ambient temperature is lower than the standard temperature, the zoom lens 110 is moved to the wide-angle end. As a result, in the digital video camera 100 according to the second embodiment, the reference plane BS can be maintained in the approximately uniform position regardless of the ambient temperature. That is to say, the projecting amount (retrojecting amount of 3D image is prevented from changing according to the temperature change. Therefore, satisfactory 3D images can be provided to the user.

In the second embodiment, the moving position of the zoom lens 110 is determined based on the temperature information acquired at the time of power ON. However, the moving position of the zoom lens 110 may be determined based on the temperature information acquired just before the 3D conversion lens 500 is attached, by acquiring the temperature information at predetermined cycles after the power ON. As a result, the moving position of the zoom lens 110 can be determined accurately based on the latest temperature information.

When the 3D conversion lens 500 is attached and the zoom lens 110 is moved to a position according to the temperature information, the zoom lens 110 may be moved from the current position directly to the position according to the temperature information. In another manner, the zoom lens 110 may be once moved to the telephoto end and thereafter to a position according to the temperature information.

### 3. Third Embodiment

A third embodiment will be described below with reference to the drawings. Description about the same configuration as that of the digital video camera 100 in the first embodiment will be omitted.

The digital video camera 100 according to the third embodiment has an electronic zoom function. The electronic zoom is not zoom by means of the optical system, but zoom for electronically processing an image imaged on the CCD image sensor 180 so as to enlarge the image. In the third embodiment, when the electronic zoom is performed by an operating member 250 and the zoom lever 260, it is performed by an image processor 190 according to an instruction of the controller 210.

When the electronic zoom for enlarging an L image and an R image to a double size (length) is performed, the parallax amount therebetween is doubled. That is to say, the projecting amount and the retrojecting amount become double, and thus the image might be very less-visible for the user. Further, when the parallax amount has a certain value or more, the user cannot recognize the image as a stereoscopic image. In the third embodiment, therefore, when the user makes a control for the electronic zoom is performed by the user, the zoom lens 110 of the digital video camera 100 is moved according to the electronic zoom amount so that the parallax amount between an L image and an R image does not become too large (the parallax amount after zoom does not became a predetermined value or more). As a result, the reference plane BS is moved. This will be described in detail below.

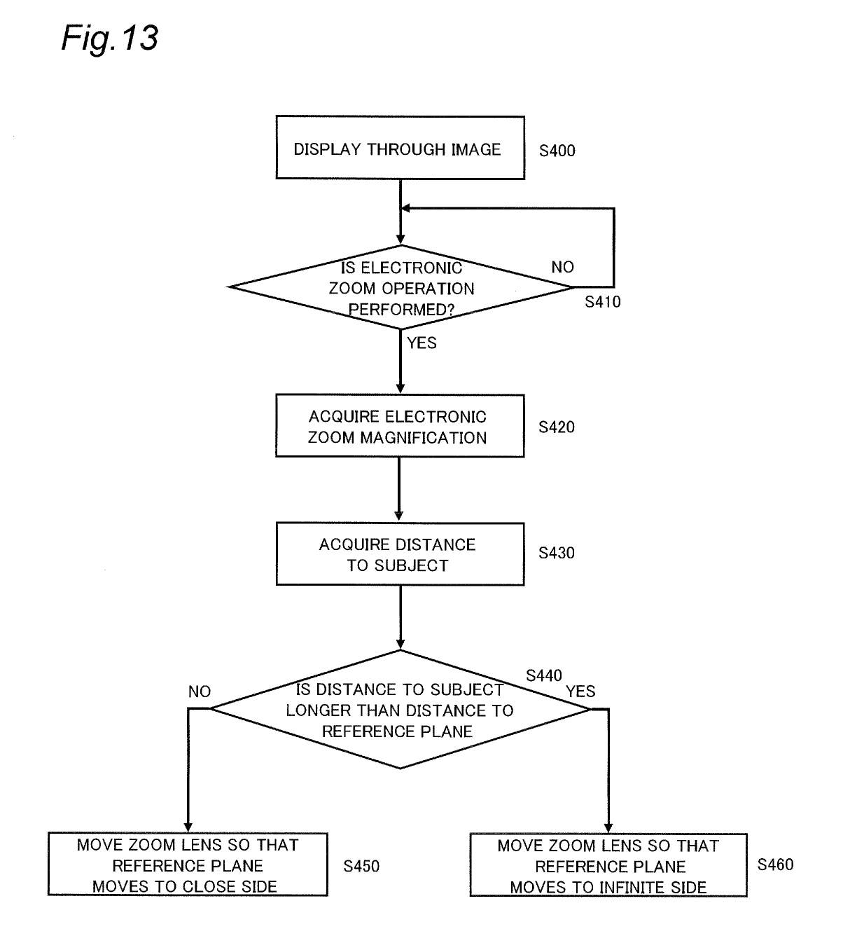

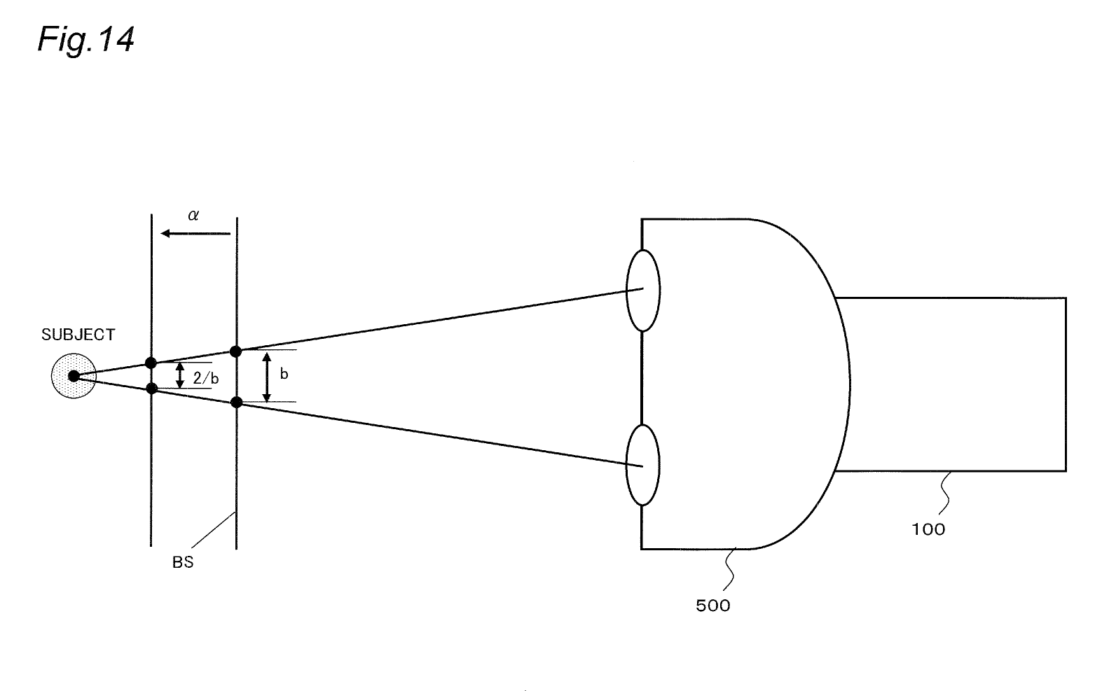

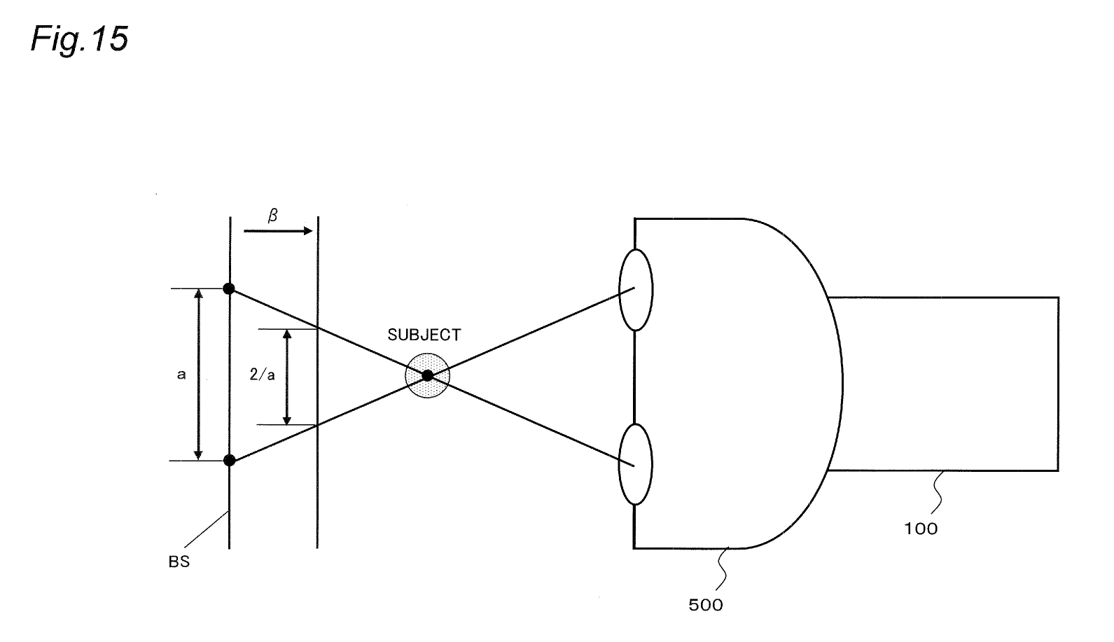

FIG. 13 is a flowchart for describing the moving control of the zoom lens according to presence or absence of the electronic zoom control. FIGS. 14 and 15 are diagrams for describing the change in the position of the reference plane BS.

When the recording mode is set, the controller 210 displays a through image on the liquid crystal display monitor 270 (S400). In a state that the through image is displayed on the liquid crystal display monitor 270, the controller 210 monitors and determines whether the electronic zoom operation by the user is performed on the digital video camera 100 (S410).

When the determination is made that the electronic zoom operation by the user is performed, the controller 210 acquires a magnification of the electronic zoom based on the electronic zoom operation performed by the user (S420). The magnification of the electronic zoom can be obtained based on an operating amount of the zoom lever 260 (an operating time and an operating direction). The controller 210 then acquires a distance from a predetermined lens in the 3D conversion lens 500 (for example, a lens closest to the subject side) to the subject (S430). As the distance to the subject, the focal distance can be used.

The controller 210 determines whether the distance from the predetermined lens in the 3D conversion lens 500 to the subject is longer than the distance to the reference plane BS (S440). When the distance to the subject is longer than the distance to the reference plane BS as shown in FIG. 14, namely, the subject is present on the retrojecting side, the zoom lens 110 is moved so that the reference plane BS is moved to the infinite side (a direction where the reference plane BS goes away from the digital video camera 100) (S460). For example, when the magnification of the electronic zoom is double, the reference plane BS is moved to an infinite side as shown by an arrow a so that the parallax amount between the L image and the R image on the reference plane BS becomes b/2. When the magnification of the electronic zoom is triple, the reference plane BS is moved to the infinite side so that the parallax amount on the reference plane BS becomes b/3. That is to say, the reference plane BS is moved to the infinite side so that the parallax amount between the L image and the R image on the reference plane BS becomes 1/(the magnification of the electronic zoom). The moving position of the reference plane BS can be calculated geometrically based on the distance to the subject and the distance to the reference plane BS. When the reference plane BS is moved in such a manner, even if the electronic zoom is performed, the parallax amount between the L image and the R image of the subject is maintained uniformly.

On the other hand, when the distance to the subject is shorter than the distance to the reference plane BS as shown in FIG. 15, namely, the subject is present on the projecting side, the zoom lens 110 is moved so that the reference plane BS is moved to a close side (a direction where the reference plane BS closes to the digital video camera 100) (S450). For example, when the magnification of the electronic zoom is double, the reference plane BS is moved to the close side so that the parallax amount between the L image and the R image on the reference plane BS becomes a/2. Further, when the magnification of the electronic zoom is triple, the reference plane BS is moved to the close side so that the parallax amount between the L image and the R image on the reference plane BS becomes a/3. That is to say, the reference plane BS is moved to the close side so that the parallax amount between the L image and the R image on the reference plane BS 1/(the magnification of the electronic zoom). The moving position of the reference plane BS can be geometrically calculated based on the distance to the subject and the distance to the reference plane BS. When the reference plane BS is moved in such a manner, even if the electronic zoom is performed, the parallax amount between the L image and the R image of the subject is maintained uniformly.

In the third embodiment, when a control for the electronic zoom is made by the user, the position of the reference plane BS is moved so that the parallax amount between the L image and the R image does not become too large. That is to say, the zoom lens 110 of the digital video camera 100 is moved according to the operating amount of the electronic zoom. As a result, even if the electronic zoom is performed, the parallax amount between the L image and the R image is prevented from being too large after zoom. Therefore, the user can satisfactorily recognize the stereoscopic image even if the electronic zoom is performed.

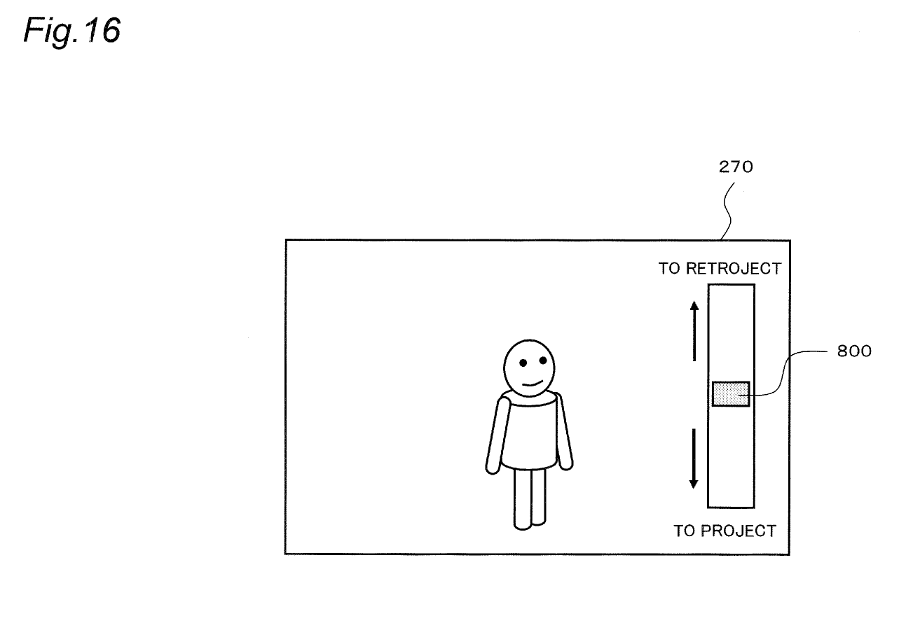

The position of the reference plane BS may be changed by the user. FIG. 16 is a diagram for describing the change in the reference plane position by the user. When an operation for adjusting the reference plane position using the operating member 250 and the zoom lever 260 is made by the user, an adjusting lever 800 for adjusting the reference plane position is displayed on the liquid crystal display monitor 270. When the adjusting lever 800 is operated by the user to the retrojecting side and the projecting side, the position of the reference plane BS may be changed according to the operating amount. As a result, the user can adjust the projecting amount and the retrojecting amount of images.

The determination whether the distance to the subject is longer than the distance to the reference plane or not (whether the subject is on the retrojecting side or the projecting side) may be made according to whether right and left positions of the subject in a left-eye image and a right-eye image imaged on the CCD image sensor 180 are reversed or not. When the right and left positions of the subject are reversed, it means that the distance to the subject is shorter than the distance to the reference plane, namely, the subject is on the projecting side. When the positions are not reversed, it means that the distance to the subject is longer than the distance to the reference plane, namely, the subject is on the retrojecting side.

### 3. Another Embodiment

The first to third embodiments are described as embodiments. However, technical ideas of these embodiments can be applied also to another embodiment. Another embodiment will be described below.

The optical system 101 and a drive system of the digital camera 100 are not limited to those shown in FIG. 5. For example, FIG. 5 shows the optical system 101 composed of three groups, but may be composed of another groups of lenses. Each of the respective lenses may be configured as one lens or a lens group including a plurality of lenses.

The first to third embodiments illustrate the CCD image sensor 180 as an imaging unit, but the imaging unit is not limited to this. For example, the imaging unit may be composed of a CMOS image sensor or an NMOS image sensor.

In the first embodiment, the zoom lens 110 is moved to the telephoto end as the operation after the attachment of the 3D conversion lens 500. However, the operation after the attachment of the 3D conversion lens 500 is not limited to such a configuration. The zoom lens 110 may be moved to the wide-angle end or another position according to an optical property of the 3D conversion lens.

In the second embodiment, when the ambient temperature is higher than the standard temperature, the zoom lens 110 is moved towards the telephoto end, and when the ambient temperature is lower than the standard temperature, the zoom lens 110 is moved towards the wide-angle end. However, the configuration does not have to be limited to this. For example, the 3D conversion lens 500 is such that when the ambient temperature is higher than the standard temperature, the reference plane BS closes to the 3D conversion lens 500, and when the ambient temperature is lower than the standard temperature, the reference plane BS goes away from the 3D conversion lens 500. In this case, when the ambient temperature is higher than the standard temperature, the zoom lens 110 may be moved towards the wide-angle end, and when the ambient temperature is lower than the standard temperature, the zoom lens 110 may be moved towards the telephoto end. In other words, the zoom lens 110 may be moved so that the reference plane BS is maintained in the approximately same position regardless of the ambient temperature.

### INDUSTRIAL APPLICABILITY

The technical ideas of the embodiments can be applied to imaging apparatuses such as a digital video camera and a digital still camera.

What is claimed is:

1. An imaging apparatus to which a 3D conversion lens is attachable, the 3D conversion lens having an optical system capable of collecting light for forming a left-eye image and light for forming a right-eye image, the imaging apparatus comprising:
an imaging device;
a zoom lens operable to change a magnification of an image to be imaged on the imaging device;
a driver operable to drive the zoom lens;
a temperature detector operable to detect an ambient temperature of the apparatus;
an attachment detector operable to detect whether the 3D conversion lens is attached to the apparatus; and
a controller operable to control the driver to cause the zoom lens to move to a predetermined position, when the attachment detector detects that the 3D conversion lens is attached to the apparatus,
wherein the controller determines the predetermined position based on a detected result of the temperature detector.

2. The imaging apparatus according to claim 1, further comprising: a recorder operable to record image data captured by the imaging device in a storage medium,
wherein when the attachment detector detects that the 3D conversion lens is attached to the apparatus during the recording of the image data, the controller controls the recorder to stop the recording of the image data, and thereafter controls the driver to cause the zoom lens to move to the predetermined position.

3. The imaging apparatus according to claim 2, further comprising:
a display operable to display the image captured by the imaging device,
wherein the controller controls the driver to cause the zoom lens to move to the predetermined position after the controller controls the display to stop the display of the image which is captured by the imaging device.

4. The imaging apparatus according to claim 3, wherein the predetermined position is a position on a side of a telephoto end.

5. An imaging apparatus to which a 3D conversion lens is attachable, the 3D conversion lens having an optical system capable of collecting light for forming a left-eye image and light for forming a right-eye image, the imaging apparatus comprising:
an imaging device;
a recorder operable to record image data captured by the imaging device in a storage medium;
a zoom lens operable to change a magnification of an image to be imaged on the imaging device;
a driver operable to drive the zoom lens;
an attachment detector operable to detect whether the 3D conversion lens is attached to the apparatus; and
a controller operable to control the recorder to stop the recording of the image data when the attachment detector detects that the 3D conversion lens is attached to the apparatus during the recording of the image data, and thereafter control the driver to cause the zoom lens to move to a predetermined position.

6. The imaging apparatus according to claim 5, further comprising: a display operable to display the image captured by the imaging device,
wherein when the attachment detector detects that the 3D conversion lens is attached to the apparatus during the recording of the image data, the controller controls the display to stop the display of the image captured by the imaging device, and thereafter controls the driver to cause the zoom lens to move to the predetermined position.

7. The imaging apparatus according to claim 6, wherein the predetermined position is a position corresponding to a telephoto end.

8. An imaging apparatus to which a 3D conversion lens is attachable, the 3D conversion lens having an optical system capable of collecting light for forming a left-eye image and light for forming a right-eye image, the imaging apparatus comprising:
an imaging device;
a zoom lens operable to change a magnification of an image to be captured on the imaging device;
a driver operable to drive the zoom lens;
an electronic zoom unit operable to electronically process the image captured on the imaging device to enlarge the image; and
a controller operable to control the driver so that a parallax amount between the left-eye image and the right-eye image is not a predetermined amount or more, and move the zoom lens, when the electronic zoom unit enlarges the image which is captured on the imaging device.
